(19) United States
(12) Patent Application Publication
(10) Pub. No.: US 2024/0392880 A1
(43) Pub. Date: Nov. 28, 2024

(54) INSERT ARRANGEMENT, CONTROL VALVE AND PROCESS PLANT

(71) Applicant: Samson Aktiengesellschaft, Frankfurt am Main (DE)

(72) Inventor: Johannes Jantz, Schmitten (DE)

(73) Assignee: Samson Aktiengesellschaft, Frankfurt am Main (DE)

(21) Appl. No.: 18/696,550

(22) PCT Filed: Sep. 21, 2022
(86) PCT No.: PCT/EP2022/076152

§ 371 Date: Mar. 28, 2024

(30) Foreign Application Priority Data
Sep. 29, 2021 (DE) 10 2021 125 273.3

(51) Int. Cl. F16K 1/54; F16K 27/02; F16K 27/08

(52) U.S. Cl. CPC F16K 1/54; F16K 27/02; F16K 27/08

(57) ABSTRACT

An insert arrangement may be used with a control valve for adjusting a process fluid flow of a process plant (e.g., a chemical plant, a power plant, a food processing plant) having a valve housing, a housing cover and an actuator. The insert arrangement may include an annular mounting flange which can be inserted between the valve housing and the housing cover. An insert sleeve may be reversibly attachable or attached radially on the inner side of the mounting flange for guiding the actuator.

### CROSS REFERENCE TO RELATED APPLICATIONS

This patent application is a U.S. National Stage Application of International Application No. PCT/EP2022/076152, filed Sep. 21, 2022, which claims priority to German Patent Application No. 10 2021 125 273.3, filed Sep. 29, 2021, each of which is incorporated herein by reference in its entirety.

### BACKGROUND

### Field

The disclosure relates to an insert arrangement for a control valve for adjusting a process fluid flow of a process plant. The disclosure also relates to a control valve for adjusting a process fluid flow of a process plant. Furthermore, the disclosure relates to a process plant, such as a chemical plant, a power plant, a food processing plant or the like.

### Related Art

A modular valve housing system for providing one of several different functional or design configurations for a globe valve is known from DE 10 2018 102 251 A1. In the known modular valve housing system, it is provided that different types of valves use the same housing body and the same housing cover. Modular adaptability is achieved by using different adapter flanges that can be inserted between the housing body and the housing cover. In the uniform interface area of the housing body and the housing cover, uniform predetermined steps and inner diameters are provided, to which the various adapter flanges are designed to complement the shape. Since the housing body and cover are usually manufactured as cast parts and then undergo complex mechanical reworking, the adapter solution described in DE 10 2018 102 251 A1 can save costs and time through standardization.

There is a desire for further improvements in costs and manufacturing effort when providing a large number of different types of control valves, in particular with different fluid flow values (KV values) and/or valve configurations.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a control valve with an insert arrangement according to the disclosure.

FIG. 2 a control valve with an insert arrangement according to the disclosure.

FIG. 3a a control valve with an insert arrangement according to the disclosure.

FIG. 3b a detailed view of the uniform mounting interface of the control valve according to FIG. 3a.

FIG. 4a a control valve with an insert arrangement according to the disclosure.

FIG. 4b a detailed view of the uniform mounting interface of the control valve according to FIG. 4a.

FIG. 5 a control valve with an insert arrangement according to the disclosure.

FIG. 6a a control valve with an insert arrangement according to the disclosure.

FIG. 6b a detailed view of the uniform mounting interface of the control valve according to FIG. 6a.

FIG. 7 a control valve with an insert arrangement according to the disclosure.

FIG. 8 a control valve with an insert arrangement according to the disclosure.

FIG. 9 a control valve with an insert arrangement according to the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

An object of the disclosure is to provide improved control valves with a wide variety of functional and design configurations in order to reduce manufacturing, assembly and maintenance costs while meeting the highest quality requirements, for example in terms of tightness, control accuracy, closing action, reliability and durability.

Accordingly, an insert arrangement is provided for a control valve for adjusting a process fluid flow of a process plant, such as a chemical plant, a power plant, a food processing plant or the like, wherein the control valve is provided with an actuator, a housing cover and a valve housing, wherein the valve housing may also be referred to as a housing body.

The insert arrangement may comprise an annular mounting flange which can be inserted between the valve housing and the housing cover. According to the disclosure, the insert arrangement may comprise an insert sleeve for guiding the actuator, which can be attached or is attached radially on the inner side of the mounting flange. The insert sleeve can be detached from the mounting flange in a reversible and damage-free manner. The insert sleeve and the mounting flange are always two separate components that can be connected or joined in a form-fitting or force-fitting manner. The insert sleeve is arranged and adapted to define the translational positioning movement of the actuator. For guiding the actuator, the insert sleeve of the insert arrangement according to the disclosure is adaptable or adapted to the actuator. The insert may be annular. The insert sleeve may have at least one further axial through-opening in addition to a central opening for guiding the actuator. The mounting flange can have several radial sleeve sections with different axial extensions. For example, the insert sleeve can have at least one radially outer sleeve section or connecting section for contacting the mounting flange, and a radially inner sleeve section for guiding the actuator. The inner sleeve section or guide section may comprise a bearing bush or the like. The inner and/or the outer sleeve section may be fully circumferentially formed, in particular solid and/or in one piece. The insert sleeve may have at least one radially centered sleeve section between the outer and the inner sleeve section, which is different from the inner sleeve section and the outer sleeve section. For example, the central sleeve section may have at least one axial opening. The axial extension of the central sleeve section may be smaller than the axial extension of the inner sleeve section and/or the outer sleeve section.

In the insert arrangement or the modular system, the mounting flange is provided with a uniform outer ring side and a uniform inner ring side. In the insert arrangement according to the disclosure, the uniform inner ring side and the outer sleeve section are implemented corresponding to each other. To form different control valves, different insert sleeves are provided in the modular system, which are identical in their outer sleeve section. The mounting flange is uniform for a large number of control valves. The uniform outer ring side of the mounting flange may be arranged to correspond to corresponding interface sections on the housing cover and the valve housing.

The mounting flange generally has a hollow cylindrical shape, preferably with an annular cross-section. The mounting flange has a first end, which may be referred to as the upper end (in particular with reference to the figures), and a second end opposite the first end, which may be referred to as the lower end. The mounting flange has an upper end, which has to be facing the housing cover (facing in the assembled state) or which has to be facing away from the valve seat or, in other words, the operation opening in the valve housing (facing away in the assembled state). The upper end of the mounting flange can be annular and/or planar, in particular in a front face oriented perpendicular to the axial direction. The mounting flange has a lower end which has to be facing away from the housing cover (facing away in the assembled state) or which has to be facing the valve seat or, in other words, the operation opening in the valve housing (facing in the assembled state). The lower end of the mounting flange can be annular and/or planar, in particular in a base face oriented perpendicular to the axial direction. In particular, the annular shoulder of the mounting flange is arranged in the portion of the upper end of the mounting flange. The annular shoulder may form the upper end of the mounting flange. The insert sleeve may be arrangeable or arranged in the portion of the upper end of the mounting flange. For example, the insert sleeve and the mounting flange can form a thread pairing and/or fit, in particular a centering fit, which extends from the upper end of the mounting flange into the interior of the mounting flange. The mounting flange and the insert sleeve may be adapted to each other in such a way that the insert sleeve can be inserted into the mounting flange from above and/or that an axial stop for holding the insert sleeve is arranged in the portion of the lower end of the mounting flange. An axial stop of the mounting flange can be arranged and/or extend at the lower end of the mounting flange and/or offset above or into the inside of the mounting flange.

Surprisingly, it has been found that the use of additional components in the form of a mounting flange and additional insert sleeve, contrary to common preconceptions, offers considerable potential for cost savings and reduced manufacturing costs. By providing the mounting flange as a further common part in addition to the common parts in the form of the housing body and/or the housing cover, the mounting flange can also be manufactured easily and cost-effectively in large quantities, for example as a cast part. All that remains is the relatively small insert sleeve or adapter sleeve for customizing a control valve to a specific application.

In one embodiment of the insert arrangement according to the disclosure, the insert sleeve is arranged and adapted to hold the actuator contact-free in relation to the mounting flange. The actuator, which generally comprises an actuator body, such as a valve piston or valve plug, and an actuator rod or the like connected to the actuator body, is held and guided by the insert sleeve in such a way that contact between the actuator and the mounting flange is avoided, preferably regardless of the position of the actuator. By exclusively using the insert sleeve to interact with the actuator without interaction of the mounting flange with the actuator, a standardized mounting flange can be used regardless of the selection of a specific actuator from a large variety of different actuators.

In an exemplary embodiment of the insert arrangement according to the disclosure, the mounting flange is arranged and adapted for contact-free arrangement in the valve housing in relation to the housing cover, wherein the insert sleeve is to be arranged between the housing cover and the mounting flange. The insert sleeve may have an axially and/or radially protruding annular shoulder. The insert sleeve may form the first or upper end of the insert arrangement, which is to be brought into contact with the housing and/or valve cover or is in contact with them in the operational assembly state. Optionally, the insert sleeve is in radial contact, in particular centering radial contact, with the valve housing. For external tightness and low-friction actuation of the control valve, it is desirable that the actuator rod, which is guided out of the valve cover through its passage opening, is radially aligned with the packing housed in the housing cover. It may also be useful for the valve plug and the valve seat to be centered. With the help of the radial centering of the insert sleeve on the valve housing, a particularly precise orientation of the guide for the actuator rod realized by the insert sleeve can be ensured.

According to an exemplary embodiment of an insert arrangement, the mounting flange is arranged and adapted to hold the insert sleeve contact-free in relation to the valve housing and the housing cover. In particular, in the insert arrangement, the interaction of the valve housing and the housing cover is realized exclusively by means of the mounting flange, preferably without direct contact of the insert sleeve with the housing cover and the mounting flange. For a standardized housing cover and a standardized valve housing, a specific insert sleeve can be easily selected from a large number of different insert sleeves especially for a particular application. As the mounting flange holds the insert sleeve contact-free in relation to the housing cover and the valve housing, the insert sleeve can be designed independently of the housing cover and the valve housing, and vice versa. The insert sleeve and the mounting flange can be adapted to each other in such a way that the mounting flange protrudes beyond the outer dimensions of the insert sleeve in the axial and/or radial direction. The mounting flange may form the first or upper end of the insert arrangement, which is to be brought into contact with the valve cover or is in contact with it in the operational assembly state.

In an exemplary embodiment of the insert arrangement, the mounting flange and the insert sleeve are adapted to each other for forming a press connection. In an exemplary embodiment of the insert arrangement, the mounting flange and the insert sleeve are adapted to each other for forming a thread pairing. In particular, the press fit or the thread pairing is designed in such a way that a predetermined operation position of the insert sleeve is clearly defined in relation to the mounting flange. Depending on the application, it may be advantageous to provide a threaded connection that is easy to assemble and disassemble, or a press connection with particularly high positional accuracy.

In another embodiment of an insert arrangement according to the disclosure, which can be combined with the previous ones, the mounting flange has a (first/and or second) axial stop and/or a (first and/or second) centering for defining an operation position for the insert sleeve. The (first) axial stop and/or the (first) centering may be arranged and adapted to define a unique operation position of the insert sleeve in relation to the mounting flange. Additionally, or alternatively, the (second) axial stop and/or the (second) centering can be arranged and adapted to define a unique operation position of the insert sleeve in relation to the valve housing. It is conceivable that the insert arrangement has a first axial stop and/or a first centering for determining the operation position of the insert sleeve in relation to the mounting flange and a second axial stop and/or a second centering for determining the operation position in relation to the valve housing. An insert arrangement with at least one axial stop can be advantageous for control valves in which one or more predetermined valve positions are to be assumed precisely, reliably and/or reproducibly. An insert arrangement with at least one centering device is particularly advantageous for control valves in which a coaxiality of the actuator in the valve housing is relevant. Additionally, or alternatively, the insert arrangement can be equipped with at least one or more adjusting means, such as a circumferential direction stop, which are arranged and adapted to determine a predetermined orientation of the insert sleeve and, if applicable, of the actuator guided therein in relation to the mounting flange and/or the valve housing. Such an adjustment means can be advantageous for use in control valves in which a rotationally asymmetrical actuator is provided and/or a valve cage and/or a throttle ring is used.

Additionally, or alternatively, in one embodiment of an insert arrangement, the insert sleeve comprises an axial stop and/or a centering means for defining an operation position for the insert sleeve. For this purpose, an annular shoulder of the insert sleeve can be provided, which is arranged and adapted in particular to be brought or brought into contact, preferably axial press contact, with the housing cover. Alternatively, the annular shoulder of the insert sleeve can also be arranged and adapted to be brought or brought into contact, preferably radial centering contact, with the valve housing. The insert sleeve and the mounting flange can be adapted to each other in such a way that the insert sleeve protrudes beyond the outer dimensions of the mounting flange in the axial and/or radial direction. The insert sleeve may be in radial contact, in particular centering radial contact, with the mounting flange and the mounting flange may be in radial contact, in particular centering radial contact, with the valve housing. In another embodiment of an insert arrangement, which can be combined with the previous ones, the insert sleeve comprises a penetration opening in the axial direction for pressure compensation. In particular, the insert arrangement comprises at least one insert seal for sealing between the mounting flange and the insert sleeve. Alternatively, or additionally, the insert arrangement comprises in particular at least one mounting flange seal for sealing between the mounting flange and the valve housing and/or between the mounting flange and the housing cover.

Additionally, or alternatively, in one embodiment, an insert arrangement can be provided with a securing means for holding the insert sleeve on the mounting flange, in particular to prevent it from rotating. The securing means may be provided in addition to or in functional union with the adjusting means.

The disclosure also relates to a control valve for adjusting a process fluid flow of a process plant, such as a chemical plant, a power plant, a food processing plant or the like.

The control valve comprises a valve housing and a housing cover. The valve housing has an inlet opening and an outlet opening as well as a passage opening arranged between them. The control valve also has a valve seat that surrounds the passage opening. The valve seat may be fully circular. Furthermore, the control valve comprises an actuator that is movable in the valve housing and is attached to an actuator rod. The actuator can be brought into sealing engagement with the valve seat. The valve seat and the actuator are adapted to one another for sealing engagement. The housing cover has a through-opening for the actuator rod. The housing cover is arranged opposite the passage opening. The housing cover is attached or can be attached to the valve housing. The control valve has an actuator that is translationally movable along a stroke axis, such as a globe valve member, for example a valve piston or valve plug. The actuator is adapted to adjust a process fluid flow in a process plant. According to the disclosure, the control valve is equipped with an insert arrangement for guiding the actuator, which can be embodied as described above.

The valve seat does not realize an insert sleeve. Typically, the valve seat is in direct contact with the valve housing of the control valve in the portion of a seat bridge. Optionally, the valve seat can be configured as a component unit with the mounting flange. Alternatively, the valve seat and the mounting flange can be adapted to one another, wherein in particular the position and orientation of the mounting flange in the valve housing are determined by the valve seat or the position and orientation of the valve seat in the valve housing are determined by the mounting flange. The mounting flange and the valve seat may be in direct contact with each other in the operational mounting state. It is clear that the valve seat and the insert sleeve are different components. In an operational assembly state of a control valve fitted with an insert assembly, the valve seat and the insert sleeve are arranged separately from each other within the valve housing.

The valve housing (the housing body) has a process fluid inlet, a process fluid outlet and a process fluid passage arranged between the process fluid inlet and the process fluid outlet. Furthermore, the housing body comprises an operation opening for inserting the actuator and/or an actuator rod for actuating the actuator along the stroke axis. At the process fluid inlet and at the process fluid outlet of the valve body, mounting devices, for example flange-like fastening sections, can be provided for connecting a pipeline for guiding the process fluid. A valve seat can be provided on the process fluid passage of the valve housing, which can cooperate with the actuator in a closing and/or opening manner. The valve seat can be an annular and/or sleeve-shaped seat of an insertable component. The valve seat can have one or more sealing surfaces for sealing cooperation with the actuator, in particular a valve piston or valve plug. A sealing device, such as an annular seal, can be arranged between the valve seat and the valve housing.

The valve housing can be a particularly one-piece body made of one or more media- and/or temperature-resistant materials. For example, the valve housing can be a one-piece cast metal body or forged body, which is sectionally provided with a machined, for example polished and/or coated, for example painted, powder-coated, chrome-plated, enameled, galvanized or the like, surface. It may be preferred that the valve housing defines a housing interior whose openings are preferably realized exclusively by the process fluid inlet, the process fluid outlet and the operation opening. It is conceivable that a housing body has further openings to the inner space, for example openings for introducing sensors or one or more further process fluid inlets or outlets.

The housing cover is arranged and adapted to cover the operation opening. The housing cover comprises a through-opening extending in the direction of the stroke axis to accommodate the actuator rod. In particular, the housing cover can comprise a fastening section for mounting an actuator, in particular a pneumatic actuator, or a yoke, a lantern or the like for supporting an actuator. The through-opening may be free sealing means for sealing between the housing cover and the actuator rod. The through-opening may be free of guides, such as a plain bearing, a ball bearing or the like, for translationally guiding the actuator. With regard to the actuator rod, the housing cover can be dimensioned in such a way that the smallest clear width, in particular the smallest inside diameter, of the housing cover, in particular the through-opening, is at least 1 mm or at least 5 mm larger than the outside diameter of the actuator rod in the portion that extends through the through-opening of the housing cover. The housing cover can be formed from a temperature- and/or media-resistant material. It is conceivable that the same material is selected for the valve housing and the housing cover. The housing cover and the valve housing can be designed for mounting the housing cover in direct contact with the housing body. For example, the housing body and the housing cover can have corresponding flange sections for attaching the housing cover to the housing body. The housing cover can have a plate-like cover section, which can be designed to completely close the operation opening of the valve housing in the radial direction and in the circumferential direction with respect to the stroke axis, with the exception of the through-opening.

In an exemplary embodiment of a control valve, the insert sleeve and the actuator, in particular the actuator rod, are adapted to each other in such a way that (i) the insert sleeve has a guide surface which corresponds to an outer circumferential surface of the actuator, (ii) the insert sleeve has a guide surface which corresponds to a circumferential surface of the actuator rod; or (iii) the insert sleeve has a guide surface and the actuator has a guide cylinder which corresponds to the guide surface. The guide surface and/or the guide cylinder may be arranged coaxially to the control axis of the control valve. The guide surface and the outer circumferential surface, the guide surface and the circumferential surface or the guide surface and the guide cylinder can be shape-adapted to one another with a sliding fit or a clearance fit. In general, a sliding fit or a clearance fit can be formed between the actuator and the insert sleeve in order to ensure particularly reliable and/or precise linear guidance of the actuator by the insert sleeve.

According to an exemplary embodiment of a control valve, the housing cover and the valve housing delimit an annular receiving area for an annular shoulder of the mounting flange and/or an annular shoulder of the insert sleeve. The mounting flange can have an essentially hollow cylindrical sleeve area, in which the receptacle for the insert sleeve is formed, and a radially protruding annular shoulder, in particular in the form of a flange collar. The insert sleeve can have an essentially hollow cylindrical core area, in which the guide for the actuator rod is formed, and a radially protruding annular shoulder, in particular in the form of a flange collar. The annular shoulder is clamped in the axial direction between the housing cover and the valve housing. The annular shoulder can be fully circular or comprise several, in particular three, four or five, annular shoulder sections protruding circumferentially from the sleeve area or the core area. The annular shoulder sections can be evenly distributed around the outer circumference in the circumferential direction. Alternatively, the annular shoulder sections can be unevenly distributed in the circumferential direction. This allows a clear mounting position to be defined. Alternatively, or additionally, the annular shoulder of the mounting flange and/or the annular shoulder of the insert sleeve can be held in the radial direction between an axial protrusion of the housing cover and a radially inner retaining wall section of the valve housing. Optionally, the annular shoulder of the insert sleeve protrudes in the axial direction beyond the mounting flange, in particular axially, and is supported on the housing cover. Optionally, the mounting flange and/or the insert sleeve is formed without an annular shoulder.

According to one embodiment of a control valve, the housing cover covers an operation opening for inserting the actuator and/or the control rod. A sealing element surrounding the operation opening, such as a sealing ring, a sealing cord or the like, is arranged, in particular braced, between the housing cover and the valve housing. In particular, the sealing element is arranged contact-free relative to the mounting flange and/or the insert sleeve.

In a special embodiment of a control valve, which can be combined with the previous ones, the control valve comprises a valve cage and/or a throttle ring. The valve cage and/or the throttle ring is braced in the axial direction between the mounting flange and the housing cover or is formed as a component unit with the valve cage. According to an exemplary embodiment of a control valve, the mounting flange is formed as a component unit with the valve cage and/or the throttle ring. The valve cage and/or the throttle ring may be braced in the axial direction between the housing cover and the valve seat, in particular between the mounting flange and the valve seat.

In a further embodiment of a control valve, which can be combined with the previous ones, the valve housing, the mounting flange and/or the housing cover comprises or consists of a cast part. Alternatively, or additionally, the insert arrangement, in particular the insert sleeve, may comprise or consist of a turned part.

Furthermore, the disclosure relates to a process plant comprising a plurality of control valves embodied as described above. It should be understood that the control valves of the process plant can be embodied in various ways according to the disclosure, i.e. the control valves need not be identical. In particular, the process plant comprises a plurality of control valves according to the disclosure with similar valve housings, housing covers and mounting flanges and different insert sleeves. The disclosure can also comprise a set of process engineering control valves for one process engineering system or several process engineering systems, which has a plurality of similar valve housings, a plurality of similar housing covers and a plurality of similar mounting flanges as well as a plurality of different insert sleeves.

The process plant with a plurality of control valves can comprise at least two different, in particular similar, mounting flanges and/or two different insert sleeves, wherein the insert sleeves of the plurality of control valves can be inserted alternately into the different mounting flanges.

The disclosure can also comprise a modular adapter system with several different insert sleeves, each for an individual functional or design configuration for a control valve. The modular adapter system can, for example, comprise several different insert sleeves or adapters for the design configuration of the control valve as a cone valve. For example, an individual adapter insert sleeve can be provided for a configuration of the control valve as an emergency-closing valve, emergency-opening valve, pressure-balanced control or closing valve or the like. For example, an insert sleeve of different configurations of a cone valve can be defined for different control ranges, in particular a nominal flow rate, a minimum flow rate (or a closing movement) and/or a maximum flow rate, in particular with regard to a specific process medium and/or a specific process pressure range. It is also conceivable that different insert sleeves can be provided for different cage valve configurations for providing differently configured control valves. It should be understood that in the modular adapter system, the same housing body, the same housing cover and the same mounting flange are provided for the different design or functional configurations, wherein the functional or design configuration is defined by a respective insert sleeve.

It can be seen as the core idea of the insert arrangement according to the disclosure and a control valve equipped with it that the same housing cover and the same housing body and the same mounting flange can be used in conjunction with a functional and/or design configuration adapter, which according to the disclosure can be freely selected from a range of different insert connectors, but which are all assembly-compatible with respect to the same mounting flange. By selecting a suitable insert sleeve for the conditions prevailing in a respective associated process, a control valve can be easily configured to suit without requiring a complete redesign of the valve.

An insert arrangement according to the disclosure is generally provided with the reference sign 10. The insert arrangement 10 according to the disclosure comprises as essential components a mounting flange 11 and an insert sleeve 21. A control valve according to the disclosure is generally provided with the reference sign 1. As essential components, the control valve 1 according to the disclosure comprises a valve housing 3, a housing cover 5, an actuator 7 and an insert arrangement 10.

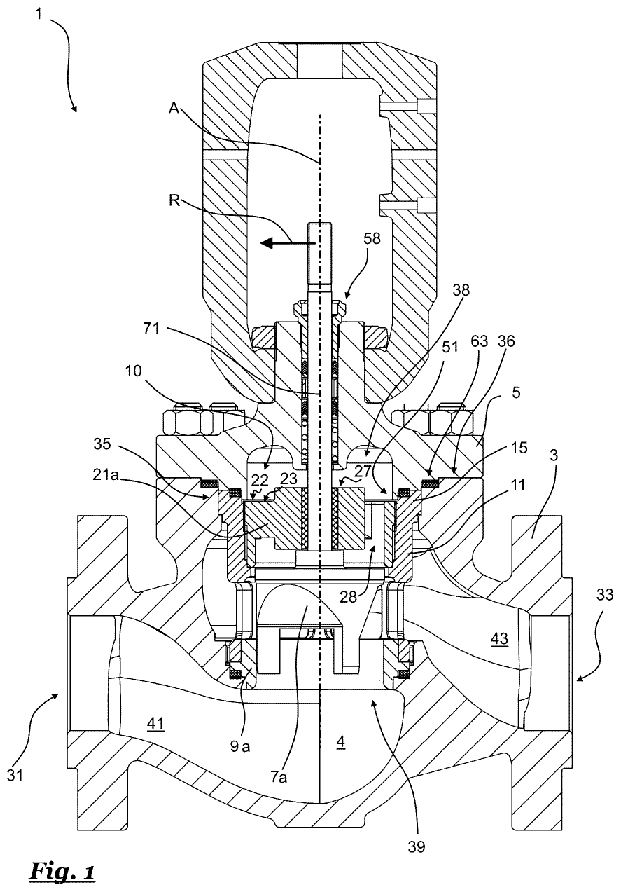

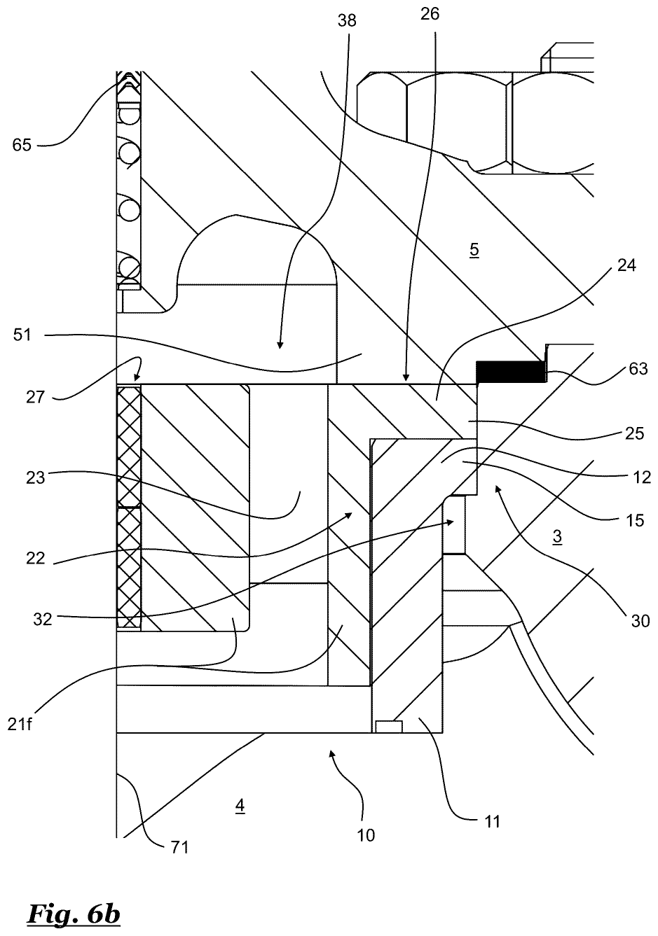

The control valves 1 illustrated in FIGS. 1-5 below and the insert arrangement 10 used therein differ essentially only in the actuators 7 designed and the corresponding insert sleeves 21 and valve seats 9, whose reference signs are supplemented by different letters (a-e) to simplify readability. FIGS. 6a-9 show further control valves according to the disclosure with alternative insert sleeves 21, the reference signs of which are supplemented by other letters (f-i) to simplify readability.

The basic structure of the control valve modular system consists of a valve housing or housing body 3 with a housing cover 5 fitted on top and a mounting flange 11 inserted therein. The cover 5 and the body 3 define a housing interior 4, which is intended to at least partially accommodate process fluid. When the control valve 1 is open, the process fluid can flow from a process fluid inlet 31 through a process fluid passage or a passage opening 39 to a process fluid outlet 33 of the housing body 3. The valve 1 can be actuated with the aid of the actuator rod 71, which carries the actuator 7 of the valve 1 and with the aid of which the actuator 7 is linearly movable along the stroke axis A. The actuator rod 71 is guided out of the housing interior 4 through the operation opening 38. The cover 5 closes this operation opening 38.

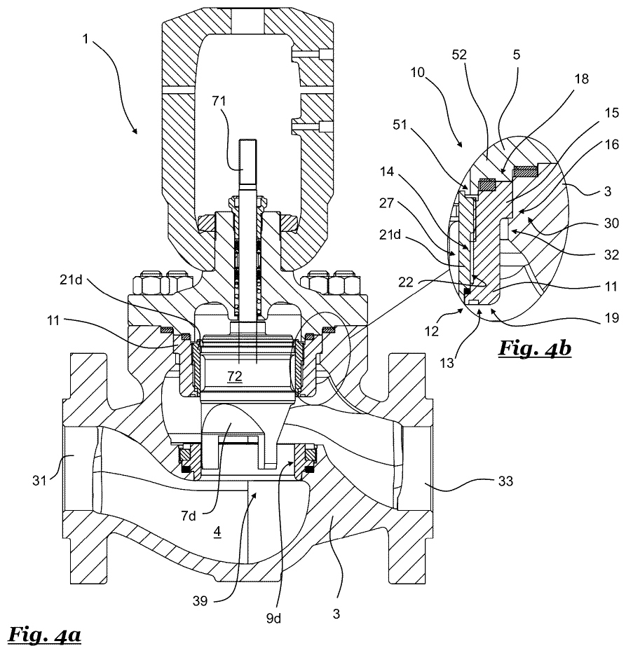

The housing cover 5 sits with a contact ring surface 53 on a corresponding support ring surface 36 of the housing body 3. In the portion of the support ring surface, the housing cover 5 as well as the housing body 3 can be penetrated in axial direction A by several corresponding fastening receptacles, such as through bores or threaded holes, for receiving fastening means, such as fastening screws for fastening the housing cover 5 to the valve housing 3. A sealing means, such as a radial seal 63, can be arranged in or on the contact ring surface 53 or the support ring surface 36, which is arranged and adapted to prevent leakage from the housing interior 4 along the contact area between the support ring surface 36 and the contact ring surface 53. The fastening interface provided by the cooperation between the housing cover 5 and the valve housing 3, in which the mounting flange 11 of the insert arrangement 10 according to the disclosure can be inserted, is described in detail below with reference to FIGS. 3b and 4b.

The housing cover 5 has a passage opening 58 for the actuator rod 71 of the actuator 7. A stuffing box 65 or similar sealing means can be arranged in the passage opening 58. The stuffing box can be supported in axial direction A on a radial protrusion of the housing cover 5, possibly spring pretensioned, and held in the passage opening 58 by a screw sleeve opposite the radial protrusion in axial direction. The screw sleeve and, if necessary, a spring can be used to exert an axial pretensioning force on the stuffing box 65 in order to bring about a radial contact pressure of the stuffing box on the actuator rod 71, so that leakage from the interior of the housing 4 along the actuator rod 71 is avoided with the aid of the stuffing box 65.

The cover 5 and its components, such as the stuffing box 65, do not exert a mechanical guide, such as a sliding guide, on the actuator 7 or its actuator rod 71. The actuator 7 and the actuator rod 71 are free of a guide in the portion of the housing cover 5. As described below, the actuator rod 71 and thus the actuator 7 are guided in the axial direction A by means of the insert sleeve 21, which is not in contact with the housing cover 5 and its components.

A seat ring or other valve seat 9 can be attached in the portion of the process fluid passage 39. The valve seat 9 can cooperate in a sealing manner with the linear-moving actuator 7. If the actuator 7 is in a sealing closing contact with the valve seat 9, it is not possible for the process fluid to flow from the process fluid inlet 31 to the process fluid outlet 33 of the valve 1. A seal, such as a sealing ring, may be provided in the axial direction A between the valve seat 9 and the housing body 3 in the portion of its through-opening 39, which prevents leakage from the high-pressure area 41 into the low-pressure area 43.

When the control valve 1 is closed, the “wet” valve interior 4 guiding the process fluid is divided into an upstream or inlet-side portion, which may be referred to as the high-pressure area 41, and a downstream or outlet-side portion of the valve interior 4, which may be referred to as the low-pressure area 43. It should be clear that, for ease of reading, the exemplary illustration in the figures is always shown with the same flow direction from the process fluid inlet 31 to the process fluid outlet 33, wherein it is conceivable that a valve 1 may have flow in the reverse flow direction, i.e. from the process fluid outlet 33 to the process fluid inlet 31, according to the nomenclature used here, with correspondingly reversed pressure ratios.

In the embodiment of a control valve 1 according to the disclosure shown in FIG. 3a, a pressure compensation area 45 is additionally provided in the interior of the housing 4. The pressure compensation area 45 is arranged in the portion of the cover 5. The pressure compensation area 45 is located above the mounting flange 11 and the insert sleeve 21c. The process fluid from the high-pressure area 41 can flow into the pressure compensation area 45 in the direction of the stroke axis A through the actuator 7c. This means that the same process fluid pressure prevails on both sides in the axial actuating direction A of the actuator 7c. The actuator 7c is pressure-relieved so that the actuator 7c can be controlled particularly precisely by an actuator 81.

FIG. 1 shows a control valve 1 with a cone-like actuator 7a that is guided in a valve cage 37. The valve cage 37 fixes the valve seat 9a in the housing body 3. The valve cage 37 comprises several circumferentially distributed webs and windows. The valve cage 37 is held in axial direction A between the mounting flange 11 and the valve seat 9a as well as on the housing body 3 in the portion of its passage opening 39. The valve cage 37 is integrally formed in one piece on the mounting flange 11. The actuator 7a has an actuator rod 71 with which it is guided in the insert sleeve 21a for translational movement.

The insert sleeve 21a can be subdivided into several annular sections in the radial direction R. The inner annular section or guide section 27 of the insert sleeve 21a is arranged and adapted to be brought into guiding engagement with the actuator 7a. The actuator rod 71 and the guide section 27 are shape-adapted to each other. In the present embodiment illustrated in FIG. 1, the guide section 27 is equipped for this purpose with a plain bearing bush 29, in which the actuator rod 71 is guided so that it can move in translation.

The outer ring section or connecting section 22 cooperates with the mounting sleeve 11. Between the connecting section 22 and the guide section 27, the insert sleeve 21a has a central section 23. The central section 23 is penetrated in the axial direction A by an opening 28 for the process fluid. The axial extension of the central section 23 is smaller than the axial extension of the guide section 27 and the connecting section 22 in order to minimize the material requirements and weight of the insert sleeve 21a.

The axial length of the guide section 27 is optimized with regard to the required guide length for precise guiding of the actuator 7a. In the guide section 27, the actuator 7 is mounted so that it can move coaxially in translation. For this purpose, a glide fit or clearance fit can be provided between the plain bearing bush 29 and the actuator rod 71. It may be preferred that the connecting section 22 has a greater axial length than the guide section 27. The uniform connecting section 22 of the different insert sleeves 21a to 21e is described in detail below with reference to FIGS. 3b and 4b.

The insert arrangement 10 according to the disclosure is characterized by a particularly simple assembly. Before mounting the housing cover 5, the annular valve seat 9 or seat ring is first inserted into the housing 3 through the operation opening 38 and attached, for example screwed in, to the through-opening 39 in the seat bridge of the valve housing 3. The valve member 7a is then introduced into the housing 3 with the actuator rod 71. Before, with or after the actuator 7, the mounting flange 11 is pushed axially through the operation opening 38 into the housing 3 and brought into contact with the inner circumference 30 in the portion of the operation opening 38. The insert sleeve 21 is then pushed into the housing 3 through the operation opening 38. Finally, the housing cover 5 is mounted.

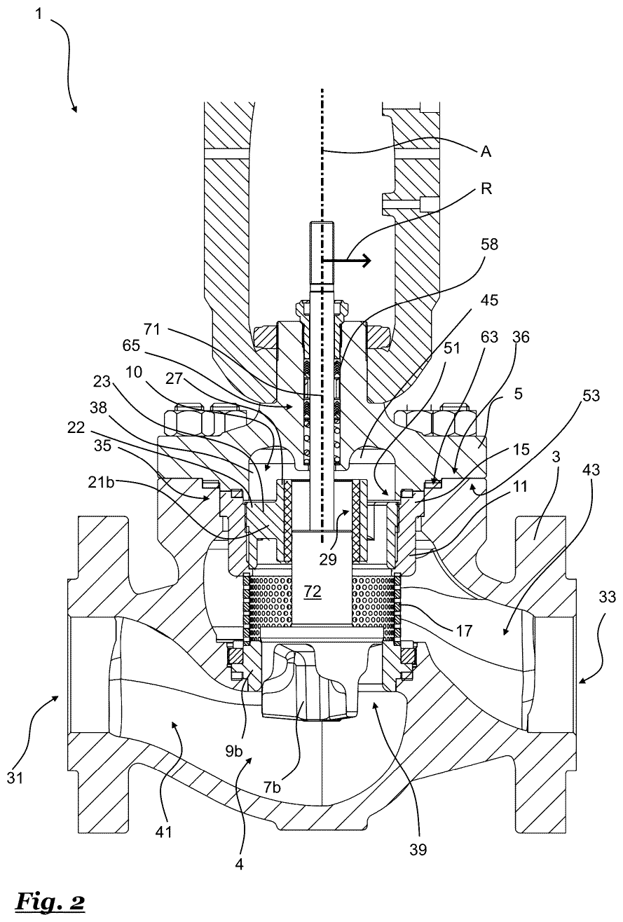

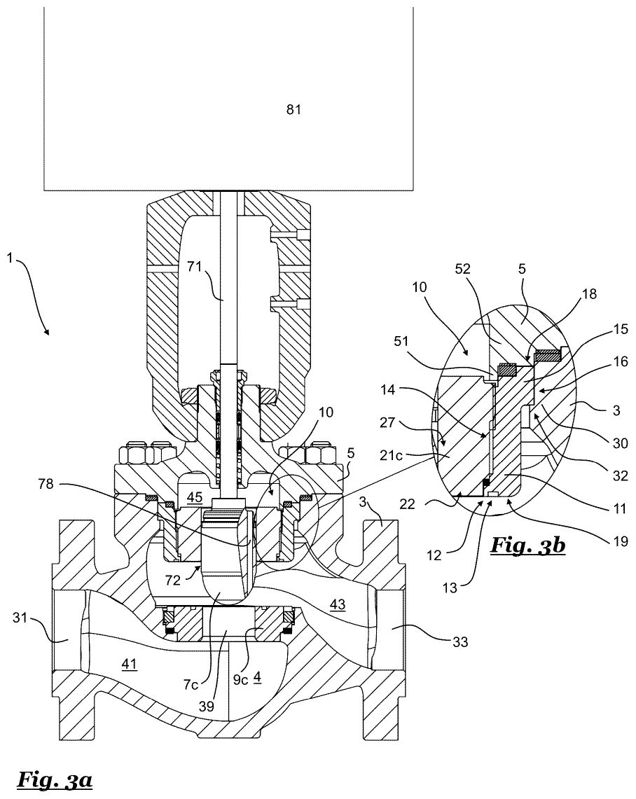

In general, as shown in FIG. 1, the mounting flange 11 extends in the axial direction A from the housing cover 5 downwards towards the valve seat 9. In the embodiment shown in FIG. 1, the mounting flange 11 extends over the entire distance in the axial direction A from the housing cover 5 to the valve seat 9. The axial extension of the insert sleeve 21a is less than the axial extension of the mounting flange 11. As in the embodiment shown in FIGS. 3a and 3b, the insert sleeve 21c can be adapted to the mounting flange 11 in such a way that the lower end of the insert sleeve 21c pointing in the axial direction or towards the valve seat 9 is aligned with the mounting flange 11. Alternatively, it may be preferred that the lower end of the mounting flange protrudes further in the axial direction A towards the valve seat 9 than the insert sleeve 21a, 21b in the operational assembly state of the control valve 1 with insert arrangement 10, as shown for example in FIGS. 1 and 2.

In general, as shown for example in FIG. 1, the mounting flange 11 extends in the axial direction A starting from the housing cover 5 downwards in the direction of the valve seat 9. In the embodiment according to FIG. 1, the mounting flange 11 extends over the entire distance in the axial direction A from the housing cover 5 to the valve seat 9. The axial extension or insert sleeve height of the insert sleeve 21a, 21b, 21c, 21d, 21e is less than the axial extension or mounting flange height of the mounting flange 11. In general, it may be provided that the insert sleeve height is in the portion 30% to 90% of the mounting flange height.

As in the embodiment shown in FIGS. 3a and 3b, the insert sleeve 21c can be adapted to the mounting flange 11 in such a way that the lower end of the insert sleeve 21c pointing in the axial direction or towards the valve seat 9 is aligned with the mounting flange 11. Alternatively, it may be preferred that the lower end of the mounting flange 11 protrudes further in the axial direction A towards the valve seat 9 than the insert sleeve 21a, 21b in the operational assembly state of the control valve 1 with insert arrangement 10, as shown for example in FIGS. 1 and 2.

The upper end of the insert sleeve 21a, 21b, 21e pointing towards the housing cover 5 can protrude beyond the mounting flange 11 in the axial direction A. Alternatively, the upper end of the insert sleeve 21c, 21d can be adapted to the mounting flange 11 in such a way that it is arranged below the upper end of the mounting flange 11 in the axial direction A.

FIG. 2 shows another embodiment of a control valve 1 according to the disclosure with a different insert sleeve 21b. Like the insert sleeve 21a described above for FIG. 1, the insert sleeve 21b has several ring sections, namely a connecting section 22, a middle section 23 and a guide section 27. The insert sleeve 21b shown here differs from the insert sleeve 21a described above essentially in the dimensions of the guide section 27 and the plain bearing bush 29 inserted therein. The plain bearing bush 29 and the guide section 27 have a large clear width (compared to the previous embodiment). The guide section 27 is arranged and adapted for guiding a guide cylinder 72 of the actuator 7. The guide cylinder 72 has a larger radial width than the actuator rod 71. The guide section 27 of the insert sleeve 21b and the guide cylinder 72 are shape-adapted to each other. The actuator 7b is equipped with a guide cylinder 72 that has a larger radius than the actuator rod 71 and a smaller radius than the closing surface that can be brought into engagement with the valve seat 9b.

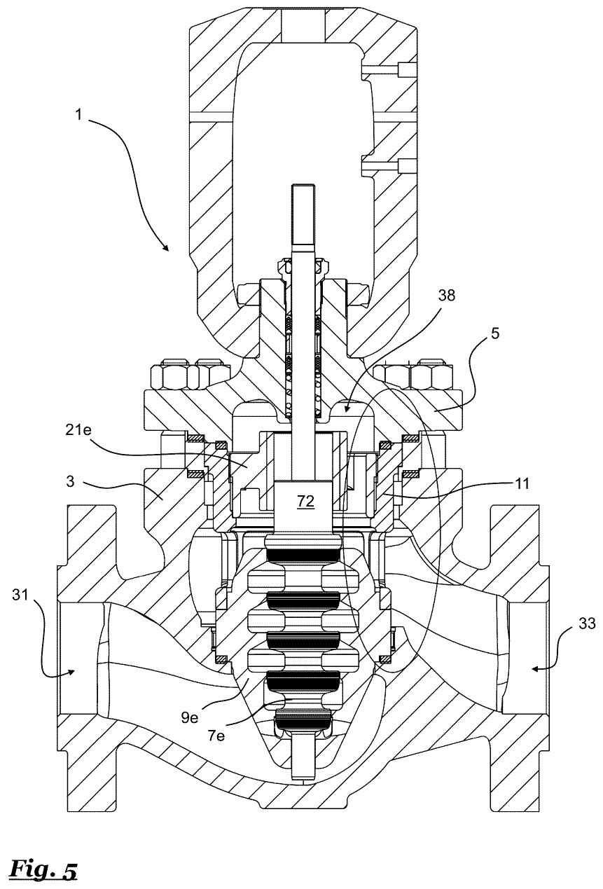

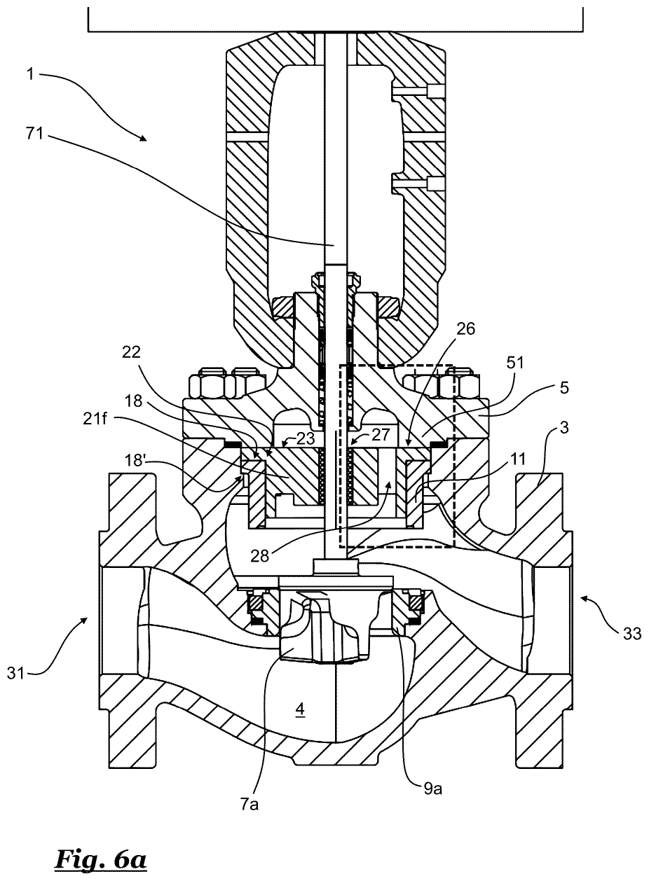

With the exception of the guide cylinder 72, the actuator 7b essentially corresponds to the actuator 7a. The control valve 1 has a valve seat 9b, which is inserted into the valve housing 3 in the portion of the through-opening 39. Between the mounting flange 11 and the valve seat 9b is a separate, sleeve-shaped throttle ring 17 as a flow divider. The throttle ring 17 shown in FIG. 2 is equipped with a large number of throttle channels with a small channel diameter. The throttle ring 17 is held on the mounting flange 11. The mounting flange 11 has an annular groove 13 at its lower end in axial direction A, which is complementary in shape to a retaining section of the throttle ring 17. The valve seat 9b has an annular groove 93 on its upper side facing the valve member 7b, which is complementary in shape to a supporting section of the throttle ring 17. The mounting flanges 11 of the embodiments with annular groove 13 according to FIGS. 2, 3a and 4a are of the same type and represent an embodiment compared to the mounting flanges of the embodiments with axial extension 17 shown in FIGS. 1 and 5.

FIG. 3a shows a further embodiment of a control valve 1 according to the disclosure. The control valve 1 according to FIG. 3a differs from the previously described control valves 1 essentially by the cartridge-shaped actuator 7c and the corresponding insert sleeve 21c. The cartridge-shaped actuator 7c has a pressure compensation bore 78 for connecting the pressure compensation area 45 with the rest of the housing interior 4. In the closed position of the cartridge-shaped valve member 7c, the pressure compensation bore 78 connects the high-pressure area 41 with the pressure compensation area 45. The actuator 7c is equipped with a guide cylinder 72, which has a larger radius than the closing surface that can be brought into engagement with the valve seat 9c.

On the side of the insert sleeve 21c, the plain bearing bush 29 and the guide section 27 have a large clearance (compared to the previous embodiment). The guide section 27 is arranged and adapted for guiding a guide cylinder 72 of the actuator 7. The guide section 27 of the insert sleeve 21c and the guide cylinder 72 are shape-adapted to each other.

The valve seat 9c is essentially similar to the valve seat 9b described above, but is free of a valve cage. The valve seat 9c as well as the mounting flange 11 each have an annular groove 93 or 13, which, however, is not covered with a valve cage. The annular groove 13, 93 can be omitted for the illustrated application or can always be provided in order to standardize production. The insert sleeve 21c consists only of the connecting section 22 and the guide section 27, which have the same axial extension.

FIG. 3b shows a detailed view of the insert sleeve 21c, the mounting flange 11 and the fastening interface of the housing 3 and the cover 5 with the mounting flange 11. The mounting flange 11 cooperates on its radial inner side 14 with the connecting section 22 of the insert sleeve 21c. The mounting flange 11 cooperates on its radially outer side 16 with the housing 3. On the axial face side, the mounting flange 11 cooperates with the cover 5. In the portion of the axial base side 19 of the mounting flange 21c, the mounting flange 11 has a radial protrusion 12 on the radially inner side 14, which realizes an axial stop for the insert sleeve 21. Along the radial inner side 14, the mounting flange 11 is at least sectionally provided with an internal thread. The insert sleeve 21 has an external thread at least sectionally on the radially outer side of the connecting section 22. The external thread of the insert sleeve 21 and the internal thread of the mounting flange 11 are adapted to each other as a thread pairing. Instead of a thread pairing, a press fit could alternatively be provided (not shown). An annular seal can be provided between the insert sleeve 21 and the mounting flange 11, for example in the portion of the radial protrusion.

The mounting flange 11 is retained in the axial direction A and in the radial direction R in a unified fastening interface between the valve housing 3 and the cover 5 of the control valve 1. As in the exemplary embodiment shown, the mounting flange 11 has its axial face side (or upper end) 18 and an annular shoulder 15 engaging a radial outer side 16 of the mounting flange 11 with the fastening interface.

On the radial outer side 16, the mounting flange 11 has an annular shoulder 15, which protrudes in the radial direction R. The outer circumference of the annular shoulder 15 is complementary in shape to the inner circumference 30 in the neck portion of the housing 3. In the axial direction A, the inner circumference 30 is open at the top towards the cover 5. The inner circumference 30 is delimited downwards in axial direction A by a retaining step 32. The retaining step 32 realizes an axial stop for the annular shoulder 15. The cover 5 has a contact section 52, which is shaped to correspond to the face side 18 of the mounting flange 11. In the axial direction A, the mounting flange 11 is held firmly, e.g., clamped, between the contact section 52 and the retaining step 32.

A further annular seal may be provided between the cover 5 and the face side 18 of the mounting flange 11. It should be understood that, for the purposes of the present application, a seal provided “between” two components is in direct contact with the two components mentioned. The cover 5 has an axial protrusion 51 protruding into the housing body 3 in the axial direction A, which is arranged and adapted to be brought into engagement with a face side section of the radial inner side 14 of the retaining flange 11. In the radial direction R, the mounting flange 11 is held between the protrusion 51 of the cover 5 and the inner circumference 30 of the valve housing 3. In the radial direction R, a press fit or a clearance fit can be provided between the retaining flange 11 and, on the one hand, the protrusion 51 and/or, on the other hand, the inner circumference 30.

In the radial direction R, neither the cover 5 nor the valve housing 3 touch the insert sleeve 21. The insert sleeve 21 is connected directly to the valve housing 3 and the valve cover 5 solely by means of the retaining flange 11. In this way, the valve cover 5 and the valve housing 3 can be designed uniformly and independently of a specific application, whereas the insert sleeve 21 can be adapted to a specific application. The adaptation of the insert sleeve 21 to any application can be carried out independently of the design of the valve housing 3 of the valve plug 5.

FIG. 4a shows a fourth embodiment of a control valve 1 according to the disclosure. FIG. 4b shows a detailed view of the mounting flange 11 according to FIG. 4a, which corresponds to the mounting flange 11 described above with reference to FIG. 3b. The same applies to the sections of the valve housing 3 and cover 5 shown in FIG. 4b. In the detailed views of the control valves 1 in FIGS. 3b and 4b, the only difference is the respective insert sleeve 21c, 21d.

The insert sleeve 21d consists only of a connecting section 22 and a guide section 27. In contrast to the insert sleeves described above, the wall thickness of the insert sleeve 21d is narrower than the wall thickness of the mounting flange 11. The clear width of the guide section 27 of the insert sleeve 21d essentially corresponds to the outer diameter of the actuator 7d. The cone-shaped actuator 7d is provided with a guide cylinder 72 in the axial direction A, the outer diameter of which essentially corresponds to the outer diameter of the cone-shaped actuator 7d. The guide section 27 of the insert sleeve 21d may be configured without a plain bearing bush. The guide section 27 is arranged and adapted for guiding a guide cylinder 72 of the actuator 7. The guide section 27 of the insert sleeve 21d and the guide cylinder 72 are shape-adapted to each other.

The cone-shaped actuator 7d is almost identical to the actuator 7a shown in FIG. 1, with the exception of the guide cylinder 72. Whereas in the embodiment shown in FIG. 1 the actuator 7a is held radially in a valve cage 37, the radial retention of the actuator 7d without valve cage 37 is achieved solely by the guide section 27. Accordingly, although the valve seat 9d is designed without valve cage 37, it is otherwise essentially the same as the valve seat 9a described above and is held at the through-opening 39.

FIG. 5 shows a control valve 1 with an actuator 7e in the form of a multi-stage valve plug with guide cylinder 72 and with a corresponding multi-stage valve seat 9e. The insert sleeve 21e essentially corresponds to the insert sleeve 21b previously described with reference to FIG. 2. The mounting flange 11 has a valve cage-like axial shape. The valve seat 9e is held against the through-opening 39 by the axial shape of the mounting flange 11.

In principle, the insert arrangement 10 has an axial stop surface or face side 18 or 26. The face side 18 or 26 corresponds to the housing cover 3. A significant difference between the embodiment shown in FIGS. 1 to 5 and those shown in FIGS. 6a to 9 is the contact-free mounting of the insert sleeves 21a-21e in relation to the valve cover 5 by means of the mounting flange 11, the face side 18 of which is supported on the valve cover 5. In the insert arrangements 10 of the figures described below, the insert sleeve 21f to 21j is in contact with the valve cover 5 at its upper end, which forms an axial stop or a face side 24, in the operational assembly state and the mounting flange 11 is held in the valve housing 3 in relation to the valve cover 5 without contact.

The person skilled in the art understands that the various insert arrangements shown in the figures, in particular FIGS. 6a to 9, can be used with a wide variety of valve members 7, wherein in particular the design of the valve member and/or the actuator rod can differ from the illustrated valve member 7a and the illustrated actuator rod 71, for example corresponding to (but not limited to) the various valve members described above.

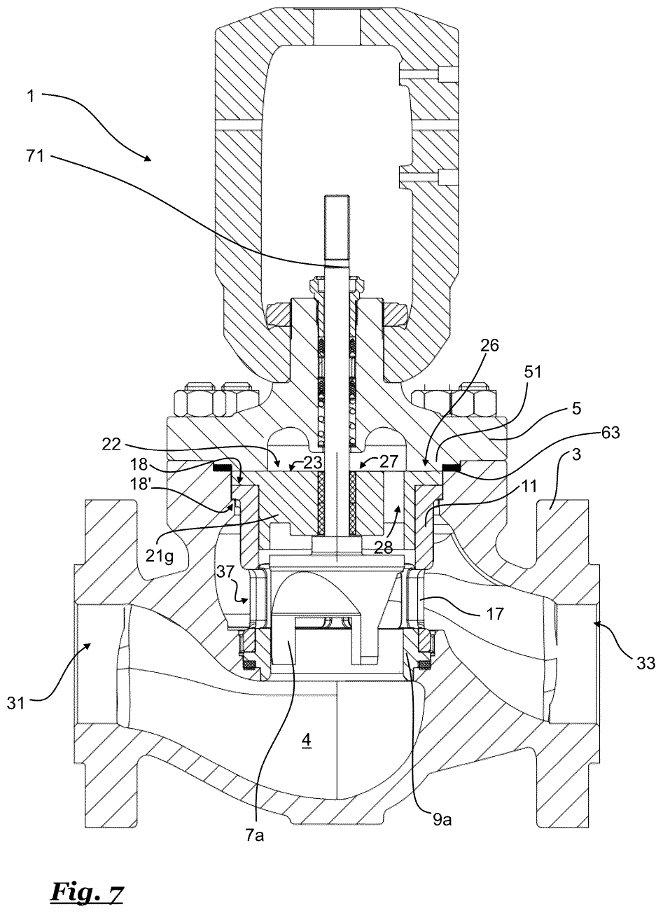

FIGS. 6a and 6b show a control valve 1 with a different embodiment of an insert sleeve 21f. Deviating from the embodiments described above, the insert sleeve 21f (as also in the sleeve of the insert sleeve 21g described below with reference to FIG. 7) comprises a radial protrusion 24. The radial protrusion 24 forms an annular shoulder 25. The annular shoulder 25 defines the upper end or face end 26 of the insert sleeve 21f and the insert arrangement 10 in the axial direction. The mounting flange 11 has two opposing axial stop surfaces, on the one hand the face side 18 and on the other hand the seat surface 18′. The face side 18 is supported on the lower side of the radial protrusion 24 and the seat surface 18′ is supported on the retaining step 32 of the valve housing 3.

The end face 26 is supported axially in contact with an annular protrusion 51 of the cover 5. The insert arrangement 10 is held in the axial direction A between the annular protrusion 51 and the retaining step 32. The force flow of the axial holding force, which holds the insert arrangement 10 in the assembled state, runs in the axial direction from the housing cover 5 into the annular protrusion 24 of the insert sleeve 21f and further into the annular protrusion 12 of the assembly sleeve 11 and from there into the valve housing 3.

FIG. 6b shows that the insert sleeve 21f and the mounting flange 11 are axially clamped together between the housing cover 5 and the valve housing 3. The insert sleeve 21f and the mounting flange can both be centered radially in the operation opening 38 on the inner circumference 30. This dispenses with nested centering between, on the one hand, the inner circumference of the housing and the mounting flange and, on the other hand, the mounting flange and the insert sleeve. There is radial play between the insert sleeve 21f and the mounting flange so that centering is clearly achieved by means of the inner circumference 30 at the operation opening 38.

In the radial direction R, the sealing element 63 is arranged between the annular protrusion 51 and the valve housing 3. The sealing element 63 is clamped axially and radially between the cover 5 and the housing 3. The mounting flange 11 is contact-free relative to the housing cover 5.

The insert sleeve 21f has a cylindrical core region, which is formed by the guide section 27 and the central section 23 with opening 28 as well as part of the connecting section 22. The embodiments of FIGS. 6a, 6b and 7 show a different uniform connecting section 22 of the insert sleeves 21f and 21g (compared to the embodiments described above).

In the radial direction R, the respective insert sleeve 21f or 21g is in radial centering contact with the inner circumference 30 of the valve housing 3 in the embodiments of FIGS. 6a, 6b and 7. Optionally, the mounting flange can also be in radial centering contact with the inner circumference 30 of the valve housing 3.

The control valve 1 illustrated in FIG. 7 largely corresponds to that described above with regard to FIG. 1, wherein the insert arrangement 10 is designed as described above with regard to FIGS. 6a and 6b.

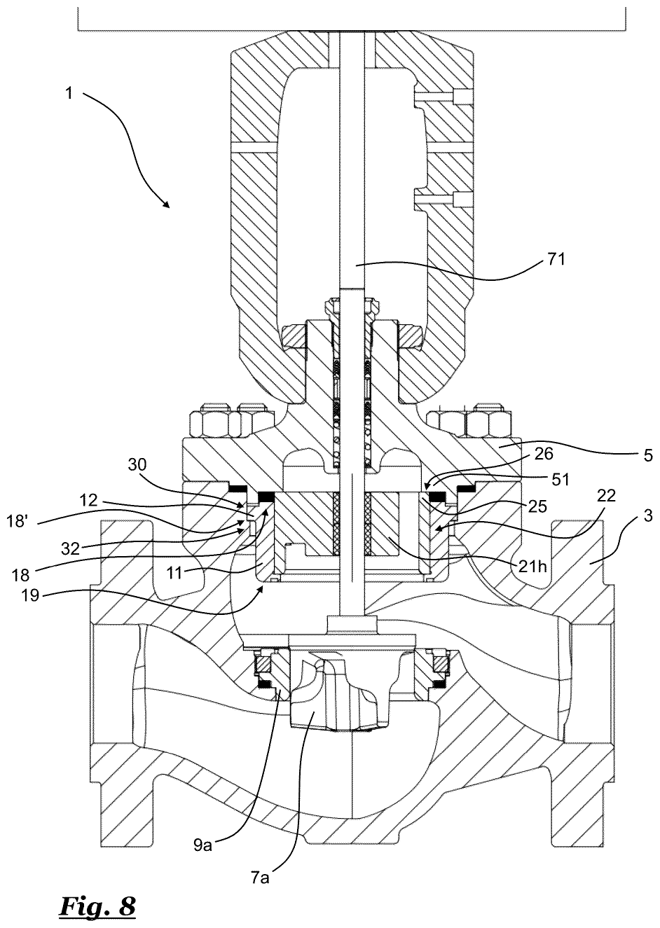

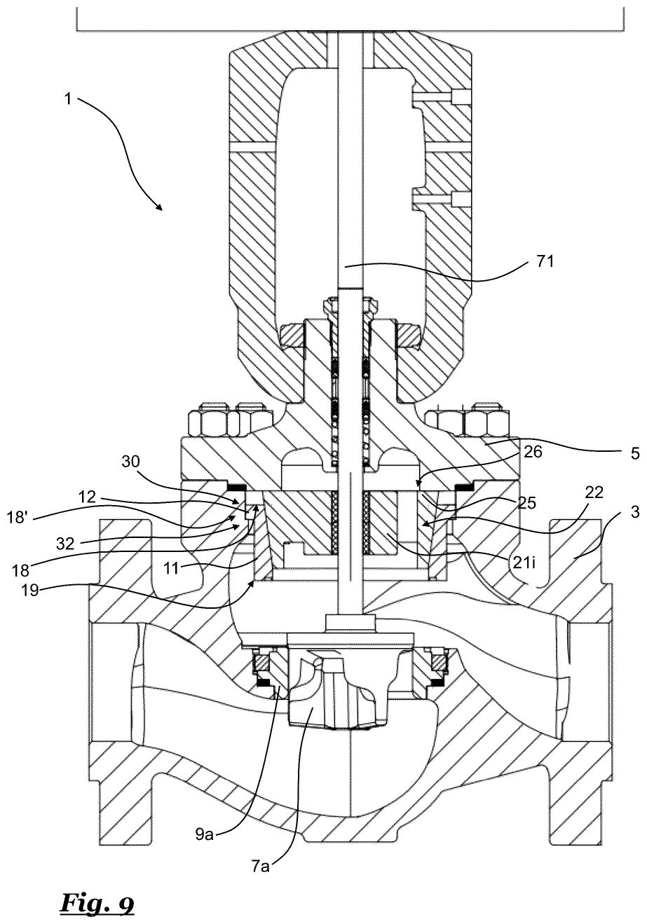

FIG. 8 shows another embodiment of a control valve 1 with an insert arrangement 10, wherein the uniform connection interface 22 between the mounting flange 11 and the insert sleeve 21h is designed in a different way compared to the previous embodiments. The contact surface at the connection interface 22 is essentially cylindrical in shape.

In the insert arrangement 10 shown in FIG. 8, its upper axial end is formed by the face side 26 of the insert sleeve 21h. The sleeve end face 26 is supported on the housing cover 5 in the axial direction A. The insert arrangement 10 is held in the axial direction A between the housing cover 5 and the retaining step 32. The force flow of the axial holding force, which holds the insert arrangement 10 in the assembled state, runs in the axial direction from the housing cover 5 into the front face 26 of the insert sleeve 21h. The axial force is transmitted from the insert sleeve 21h to the mounting sleeve 11, for example by means of an axial stop in the portion of the base end 19 of the mounting flange 11 or a press fit between the mounting flange 11 and the insert sleeve 21h. From the mounting flange 11, the force flows further into the annular protrusion 12 of the mounting sleeve 11 and from there into the valve housing 3. The mounting sleeve 11 rests with a seating surface 18′ on the retaining step 32 of the valve housing 3.

The mounting flange 11 is contact-free relative to the housing cover 5. In the radial direction R, the mounting flange 11 is supported on the inner circumference 30 of the housing 3 and the insert sleeve 21h is supported on the inner side of the mounting flange 11. As in the embodiments described above with reference to FIGS. 6a, 6b and 7, a sealing element or radial seal 63 is braced between the housing cover 5 and the housing 3. Another sealing ring is clamped between the insert arrangement 10 and the housing cover 3. In the axial direction A, the sealing ring is held and clamped between the housing cover 5 and the mounting flange 11. In the radial direction A, the sealing ring is clamped between the upper end 25 of the insert sleeve 21h and the axial protrusion 51 of the housing cover 5.

The embodiment shown in FIG. 9 of a further control valve 1 according to the disclosure with insert arrangement 10 essentially corresponds to that described above with reference to FIG. 8, wherein in particular the uniform connection interface 22 between mounting flange 11 and insert sleeve 21i is designed in a different way compared to the previous embodiments. The contact surface at the connection interface 22 has a substantially conical or frustoconical shape. The inner side of the mounting flange 11 is shape-adapted to the outer side of the insert sleeve 21i. A press fit is formed between the insert sleeve 21i and the mounting flange 11 in the operational assembly state. As described above with regard to FIG. 8, the insert arrangement 10 is supported on the front face 26 of the insert sleeve 21i on the housing cover 5. The mounting flange 11 is contact-free relative to the housing cover 5.

The features disclosed in the above description, the figures and the claims can be of importance both individually and in any combination for the realization of the disclosure in the various embodiments.

### REFERENCE SIGNS

1 Control valve
3 Valve housing
4 Housing interior
5 Housing cover
7 Actuator
9 Valve seat
10 Insert arrangement
11 Mounting flange
12 Radial protrusion
13 Annular groove
14 Inner side
15 Annular shoulder
16 Outer side
17 Throttle ring
18 Front side
18′ Seat surface
19 Base side
21 Insert sleeve
22 Connecting section
23 Center section
24 Radial protrusion
25 Annular shoulder
26 Front end
27 Guide section
28 Opening
29 Plain bearing bush
30 Inner circumference
31 Inlet opening
32 Retaining step
33 Outlet opening
35 Retaining wall
36 Support ring surface
37 Valve cage
38 Operation opening
39 Through-opening
41 High pressure area
43 Low pressure area
45 Pressure compensation area
51 Protrusion
52 Contact section
53 Contact surface
58 Passage opening
63 Radial seal
65 Stuffing box
71 Actuator rod
72 Guide cylinder
78 Pressure compensation bore
81 Actuator
93 Annular groove
A Axial direction
R Radial direction

1. An insert arrangement for a control valve for adjusting a process fluid flow of a process plant, the control valve having valve housing, a housing cover, and an actuator, the insert arrangement comprising:
an annular mounting flange adapted to be inserted between the valve housing and the housing cover; and
an insert sleeve adapted to be reversibly attachable or attached radially on an inner side of the annular mounting flange to guide the actuator.

2. The insert arrangement according to claim 1, wherein the insert sleeve is arranged and adapted to hold the actuator in a contact free manner in relation to the mounting flange.

3. The insert arrangement according to claim 1, wherein the mounting flange is arranged in a contact free manner in the valve housing with respect to the housing cover, wherein the insert sleeve being arranged between the housing cover and the mounting flange.

4. The insert arrangement according to claim 1, wherein the mounting flange is arranged and adapted to hold the insert sleeve in a contact free manner with respect to the valve housing and the housing cover.

5. The insert arrangement according to claim 1, wherein the mounting flange and the insert sleeve are adapted to each other to form a press connection.

6. The insert arrangement according to claim 1, wherein the mounting flange and the insert sleeve are adapted to each other to form a thread pairing.

7. The insert arrangement according to claim 1, wherein:
the mounting flange comprises a first axial stop and/or a first centering, adapted to define an operation position for the insert sleeve; and/or
the mounting flange comprises a second axial stop and/or a second centering, adapted to define the operation position in relation to the valve housing.

8. The insert arrangement according to claim 1, wherein the insert sleeve comprises an axial stop and/or a centering, adapted to define an operation position for the insert sleeve.

9. The insert arrangement according to claim 1, wherein the insert sleeve comprises a penetration opening in an axial direction adapted to provide pressure compensation.

10. The insert arrangement according to claim 1, further comprising a securing means for holding the insert sleeve on the mounting flange.

11. A control valve or for adjusting a process fluid flow of a process plant, the control valve comprising;
a valve housing including: an inlet opening, an outlet opening, and a passage opening arranged between the inlet opening and the outlet opening:
a valve seat surrounding the passage opening;
an actuator attached to an actuator rod and movable in the valve housing and adapted to be brought into sealing engagement with the valve seat;
a housing cover arranged opposite the passage opening and having a trough-opening adapted to the actuator rod, the housing cover being attachable to the valve housing; and
an insert arrangement including:
an annular mounting flange adapted to be inserted between the valve housing and the housing cover; and
an insert sleeve adapted to be reversibly attachable or attached radially on an inner side of the annular mounting flange to guide the actuator.

12. The control valve according to claim 11, wherein the insert sleeve and the actuator are adapted to each other such that:
the insert sleeve has a guide surface which corresponds to an outer circumferential surface of the actuator;
the insert sleeve has a guide surface which corresponds to a circumferential surface of the actuator rod; or
the insert sleeve 4 has a guide surface and the actuator has a guide cylinder corresponding to the guide surface.

13. The control valve according to claim 11, wherein:
(a) the housing cover and the valve housing delimit an annular receiving section for an annular shoulder of the mounting flange and/or an annular shoulder of the insert sleeve, the annular shoulder of the mounting flange and/or the annular shoulder of the insert sleeve being clamped in an axial direction between the housing cover and the valve housing;
(b) the annular shoulder of the mounting flange and/or the annular shoulder of the insert sleeve is held in the radial direction between an axial protrusion of the housing cover and a radially inner retaining wall section of the valve housing; and/or
(c) the annular shoulder of the insert sleeve protrudes in the axial direction beyond the mounting flange and is supported on the housing cover.

14. The control valve according to claim 11, wherein:
the housing cover is adapted to cover an insertion operation of the actuator and/or the actuator rod; and
a sealing element surrounding the operation opening is arranged between the housing cover and the valve housing.

15. The control valve according to claim 11, further comprising a valve cage and/or a throttle ring, wherein;
the throttle ring and/or the valve cage is braced between the mounting flange and the housing cover in an axial direction; or
the mounting flange is integrally formed with the valve cage.

16. The control valve according to claim 11, wherein the housing cover and/or the valve housing is a cast part, the insert arrangement including at least one turned part.

17. A process plant with a plurality of control valves according to claim 11, wherein the plurality of control valves comprise at least two different mounting flanges and/or at least two different insert sleeves, the insert sleeves of the plurality of control valves being insertable alternately into the mounting flanges.

18. The control valve according to claim 14, wherein the sealing element is arranged in a contact free manner relative to the mounting flange and/or the insert sleeve.

19. The insert arrangement according to claim 9, wherein:
the insert arrangement comprises at least one insert seal adapted to provide a seal between the mounting flange and the insert sleeve; and/or
the insert arrangement comprises at least one mounting flange adapted to provide a seal between the mounting flange and the valve housing and/or the housing cover.
